(19) United States
(12) Patent Application Publication
(10) Pub. No.: US 2025/0128482 A1
(43) Pub. Date: Apr. 24, 2025

(54) HIGH THERMAL CONDUCTIVITY COMPOSITE MATERIAL STITCHED WITH PITCH-BASED CARBON FIBER, AND METHOD FOR MANUFACTURING THE SAME

(71) Applicant: INDUSTRY-ACADEMIC COOPERATION FOUNDATION GYEONGSANG NATIONAL UNIVERSITY, Gyeongsangnam-do (KR)

(72) Inventors: Byeong Su Kwak, Gyeongsangnam-do (KR); Hun Cheol Choi, Gyeongsangnam-do (KR); Gyu Beom Park, Gyeongsangnam-do (KR); Yeong Deok Noh, Gyeongsangnam-do (KR); Jin Hwe Kweon, Gyeongsangnam-do (KR); Young Woo Nam, Gyeonggi-do (KR)

(73) Assignee: INDUSTRY-ACADEMIC COOPERATION FOUNDATION GYEONGSANG NATIONAL UNIVERSITY, Gyeongsangnam-do (KR)

(21) Appl. No.: 18/746,763

(22) Filed: Jun. 18, 2024

(30) Foreign Application Priority Data
Oct. 18, 2023 (KR) 10-2023-0139413

(51) Int. Cl. B29C 70/54; B29C 70/12; B29K 63/00; B29K 307/04; D01F 9/145

(52) U.S. Cl. CPC B29C 70/54; B29C 70/12; D01F 9/145; B29K 2063/00; B29K 2307/04; B29K 2995/0013; D10B 2505/02

(57) ABSTRACT

The present disclosure relates to a highly thermally conductive composite material in which PITCH-based carbon fiber is stitched into a prepreg laminate in which a prepreg including carbon fiber and a thermosetting resin is laminated, and a method for manufacturing the same, and the highly thermally conductive composite material may have excellent through-thickness thermal conductivity, in-plane thermal conductivity and strength.

### TECHNICAL FIELD

The present disclosure claims priority to and the benefits of Korean Patent Application No. 10-2023-0139413, filed with the Korean Intellectual Property Office on Oct. 18, 2023, the entire contents of which are incorporated herein by reference.

The present disclosure relates to a highly thermally conductive composite material stitched with PITCH-based carbon fiber, and a method for manufacturing the same. In particular, the present disclosure relates to a highly thermally conductive composite material in which PITCH-based carbon fiber is stitched into a prepreg laminate in which a prepreg including carbon fiber and a thermosetting resin is laminated, and a method for manufacturing the same.

### BACKGROUND ART

Carbon fiber reinforced plastic (CFRP) is used in various fields including transportation, construction, marine, electricity, electronics, aviation and space industries due to its excellent corrosion resistance, fatigue properties and lightness as well as excellent specific rigidity and specific strength.

Mostly commonly used polyacrylonitrile (PAN)-based carbon fiber reinforced plastic is manufactured using polyacrylonitrile and exhibits excellent strength and modulus, but has a problem of low thermal conductivity. In addition, PITCH-based carbon fiber reinforced plastic is manufactured using petroleum pitch, is inexpensive, and exhibits excellent strength.

However, since a temperature rapidly changes in the space environment, heat needs to be quickly dissipated in order to secure structural stability of spacecraft, satellites and the like and to protect internal electronic devices.

Accordingly, there are needs for a composite material having excellent thermal conductivity while maintaining similar strength to existing carbon fiber reinforced plastic.

### DISCLOSURE

### Technical Problem

The present disclosure is directed to providing a composite material having excellent thermal conductivity and strength.

However, objects to be addressed by the present disclosure are not limited to the object mentioned above, and other objects not mentioned will be clearly appreciated by those skilled in the art from the following description.

### Technical Solution

According to one aspect of the present disclosure, there is provided a highly thermally conductive composite material including: a prepreg laminate in which a plurality of prepregs including carbon fiber and a thermosetting resin are laminated; and a plurality of PITCH-based carbon fibers penetrating the prepreg laminate in the lamination direction to have both ends protruding, wherein the protruding both ends of the PITCH-based carbon fiber are bent in the direction of a surface of the prepreg laminate.

According to another aspect of the present disclosure, there is provided a method for manufacturing the highly thermally conductive composite material, the method including: preparing a prepreg laminate by laminating a plurality of prepregs including carbon fiber and a thermosetting resin; preparing a stitched prepreg laminate by stitching a plurality of PITCH-based carbon fibers so as to penetrate the prepreg laminate in the lamination direction to have both ends protruding; and compressing and bending the protruding both ends of the PITCH-based carbon fiber while heating and curing the stitched prepreg laminate.

### Advantageous Effects

A highly thermally conductive composite material according to one embodiment of the present disclosure can have excellent through-thickness thermal conductivity and in-plane thermal conductivity.

A highly thermally conductive composite material according to one embodiment of the present disclosure can have excellent strength.

Effects of the present disclosure are not limited to the above-described effects, and effects not mentioned will be clearly appreciated by those skilled in the art from the present specification.

### BRIEF DESCRIPTION OF DRAWINGS

FIG. 1 is a perspective view schematically illustrating a highly thermally conductive composite material according to the present disclosure.

FIG. 2 is a side cross-sectional view schematically illustrating a highly thermally conductive composite material according to the present disclosure.

FIG. 3 shows results of measuring through-thickness thermal conductivity of highly thermally conductive composite materials manufactured in Example 1, Example 2-1 to Example 2-3, Comparative Example 1 and Comparative Example 2.

FIG. 4 shows results of measuring in-plane thermal conductivity of highly thermally conductive composite materials manufactured in Example 1, Example 2-1 to Example 2-3, Comparative Example 1 and Comparative Example 2.

FIG. 5 shows results of measuring a failure load of an interlayer joint area depending on the performing of stitching and the stitching interval in the prepreg laminate.

### MODE FOR INVENTION

In the present specification, a description of a certain part “including” certain constituents means that it may further include other constituents, and does not exclude other constituents unless particularly stated on the contrary.

Throughout the present specification, a unit “parts by weight” may mean a ratio of weight between each component.

Throughout the present specification, a term including ordinal numbers such as “first” and “second” is used for the purpose of distinguishing one constituent from another constituent, and is not limited by the ordinal numbers. For example, within the scope of a right of the disclosure, a first constituent may also be referred to as a second constituent, and similarly, a second constituent may be referred to as a first constituent.

Throughout the present specification, a “thickness direction” and a “lamination direction” represent a direction in which a prepreg is laminated to build up layers, and may specifically mean a direction from one surface where one prepreg and another prepreg are in contact with each other to the other surface of the one prepreg.

Throughout the present specification, an “in-plane direction” means a direction perpendicular to the thickness direction (lamination direction).

Hereinafter, constitutions for specific embodiments of the present disclosure will be described in detail as follows with reference to accompanying drawings. Herein, it needs to be noted that, in adding reference numerals to constituents in each drawing, the same numerals are used for the same constituents as possible even when they are shown in different drawings.

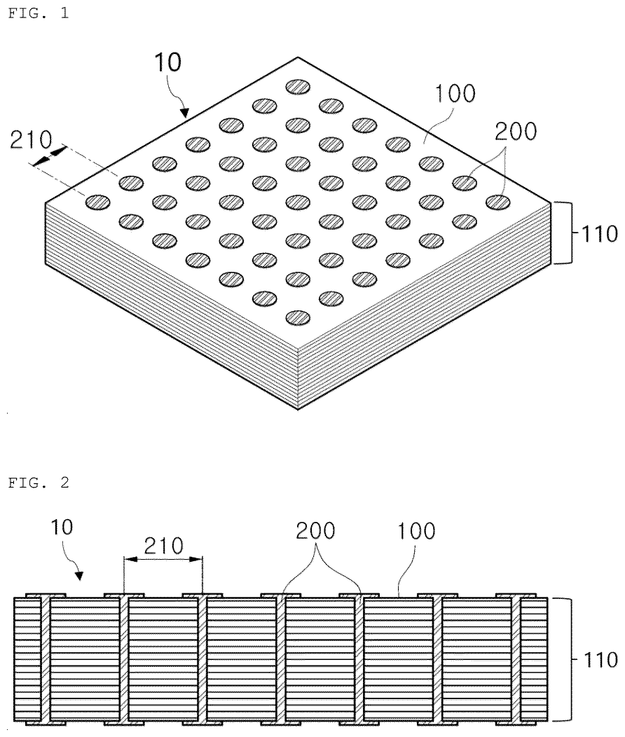

FIG. 1 is a perspective view schematically illustrating a highly thermally conductive composite material according to the present disclosure, and FIG. 2 is a side cross-sectional view schematically illustrating a highly thermally conductive composite material according to the present disclosure.

Referring to FIG. 1 and FIG. 2, a highly thermally conductive composite material 10 according to one embodiment of the present disclosure includes a prepreg 100 and PITCH-based carbon fiber 200. Specifically, the highly thermally conductive composite material 10 includes a prepreg laminate 110 in which a plurality of the prepregs 100 are laminated; and PITCH-based carbon fiber 200 penetrating the prepreg laminate 110 in the lamination direction to have both ends disposed at a predetermined interval 210 protruding, wherein the protruding both ends of the PITCH-based carbon fiber 200 are bent in the direction of a surface of the prepreg laminate 110 to have a radial shape. In addition, the prepreg 100 includes carbon fiber and a thermosetting resin.

Accordingly, one embodiment of the present disclosure provides a highly thermally conductive composite material including: a prepreg laminate in which a plurality of prepregs including carbon fiber and a thermosetting resin are laminated; and a plurality of PITCH-based carbon fibers penetrating the prepreg laminate in the lamination direction to have both ends protruding, wherein the protruding both ends of the PITCH-based carbon fiber are bent in the direction of a surface of the prepreg laminate.

The highly thermally conductive composite material according to one embodiment of the present disclosure may enhance through-thickness thermal conductivity by including a plurality of PITCH-based carbon fibers penetrating the prepreg laminate, and may enhance in-plane thermal conductivity by the protruding both ends of the PITCH-based carbon fiber being bent in the direction of a surface of the prepreg laminate. In addition, by the PITCH-based carbon fiber penetrating the prepreg laminate and bent in the direction of a surface of the prepreg laminate, strength of the highly thermally conductive composite material may be enhanced.

According to one embodiment of the present disclosure, the carbon fiber included in the prepreg may be one or more selected from among polyacrylonitrile-based carbon fiber and PITCH-based carbon fiber.

According to one embodiment of the present disclosure, the plurality of PITCH-based carbon fibers having both ends protruding may penetrate at an interval of 3 mm to 15 mm. Specifically, the plurality of PITCH-based carbon fibers having both ends protruding may penetrate at an interval of 3 mm to 15 mm, 3 mm to 13 mm, 3 mm to 10 mm, 3 mm to 8 mm, 3 mm to 5 mm, 4 mm to 7 mm, 4 mm to 6 mm, or 3 mm to 5 mm. When the plurality of PITCH-based carbon fibers having both ends protruding penetrate the prepreg laminate in the above-described range, through-thickness thermal conductivity, in-plane thermal conductivity and strength of the highly thermally conductive composite material may be enhanced.

According to one embodiment of the present disclosure, the thermosetting resin may be an epoxy resin. The epoxy resin may form an adhesive layer while being heated and cured. Using the above-described epoxy resin as the thermosetting resin may enhance interfacial binding force between the prepregs, and accordingly, the highly conductive composite thermally material may have excellent strength.

According to one embodiment of the present disclosure, the prepreg including carbon fiber and a thermosetting resin may further include a curing agent. By the prepreg including a curing agent, the thermosetting resin may be readily cured.

According to one embodiment of the present disclosure, the prepreg may have a thickness of 0.1 mm to 10 mm. Specifically, the prepreg may have a thickness of 0.1 mm to 10 mm, 0.1 mm to 7 mm, 0.1 mm to 5 mm, 0.1 mm to 2 mm, 0.2 mm to 10 mm, 0.2 mm to 8 mm, 0.2 mm to 5 mm or 0.2 mm to 3 mm. When the prepreg has a thickness in the above-described range, the PITCH-based carbon fiber may readily penetrate, and the highly thermally conductive composite material may have excellent strength.

According to one embodiment of the present disclosure, the PITCH-based carbon fiber is formed with a plurality of strands, and the protruding both ends of the PITCH-based carbon fiber may be the plurality of strands being bent in a radial shape. As described above, by the plurality of strands of the protruding both ends of the PITCH-based carbon fiber being bent in the direction of a surface of the prepreg laminate in a radial shape, a PITCH-based carbon fiber layer may be formed on the outermost surface of the prepreg laminate. As a result, in-plane thermal conductivity of the highly thermally conductive composite material according to the present disclosure may be enhanced.

According to one embodiment of the present disclosure, lengths of the protruding both ends of the PITCH-based carbon fiber may each be less than or equal to the interval between the plurality of PITCH-based carbon fibers having both ends protruding, and may be from 2 mm to 8 mm. Specifically, lengths of the protruding both ends of the PITCH-based carbon fiber may each be from 2 mm to 8 mm, 2 mm to 5 mm, 2 mm to 3 mm, 3 mm to 8 mm, 3 mm to 7 mm, 3 mm to 6 mm, 3 mm to 5 mm or 3 mm to 4 mm, and may be less than or equal to the interval between the plurality of PITCH-based carbon fibers having both ends protruding. By satisfying the above-described condition, in-plane thermal conductivity of the highly thermally conductive composite material may be enhanced. On the other hand, when lengths of the protruding both ends of the PITCH-based carbon fiber are shorter than the above-described range, a the PITCH-based carbon fiber bent in the direction of surface of the prepreg laminate is not able to form a proper PITCH-based carbon fiber layer on the outermost surface of the and prepreg laminate, and in-plane thermal conductivity strength of the highly thermally conductive composite material may be reduced.

In addition, when the PITCH-based carbon fiber penetrates the prepreg laminate, a portion of the thermosetting resin (epoxy resin) with low thermal conductivity included in the prepreg penetrates while being stained on the penetrating PITCH-based carbon fiber. Accordingly, when lengths of the protruding both ends of the PITCH-based carbon fiber are longer than the interval between the plurality of PITCH-based carbon fibers, the thermosetting resin (epoxy resin) with low thermal conductivity may be excessively formed on the outermost surface of the prepreg laminate, and in-plane thermal conductivity of the highly thermally conductive composite material may be reduced.

One embodiment of the present disclosure provides a method for manufacturing the highly thermally conductive composite material, the method including: preparing a prepreg laminate by laminating a plurality of prepregs including carbon fiber and a thermosetting resin; preparing a stitched prepreg laminate by stitching a plurality of PITCH-based carbon fibers so as to penetrate the prepreg laminate in the lamination direction to have both ends protruding; and compressing and bending the protruding both ends of the PITCH-based carbon fiber while heating and curing the stitched prepreg laminate.

According to one embodiment of the present disclosure, the curing may be performed by heating at a temperature of 100° C. to 150° C. By heating in the above-described temperature range, the thermosetting resin included in the prepreg may be readily cured.

Matters mentioned in the highly thermally conductive composite material and the method for manufacturing the highly thermally conductive composite material of the present disclosure apply equally unless they contradict each other.

Hereinafter, the present disclosure will be described in detail with reference to examples and experimental examples in order to specifically describe the present disclosure. However, examples and experimental examples according to the present disclosure may be modified to various different forms, and the scope of the present disclosure is not construed as being limited to the examples and the experimental examples described below. Examples and experimental examples of the present specification are provided in order to more fully describe the present disclosure to those having average knowledge in the art.

### Example 1. Manufacture of Highly Thermally Conductive Composite Material

A prepreg including polyacrylonitrile (PAN)-based carbon fiber, a thermosetting resin (epoxy resin, YD-128) and a curing agent (TH-431) was prepared to a size of width 10 cm×height 10 cm×thickness 0.2 mm. The thermosetting resin (epoxy resin) and the curing agent were mixed in a weight ratio of 5:3 to be used.

The prepared prepreg was repeatedly laminated to prepare an 8-layer prepreg laminate.

Into the prepreg laminate, PITCH-based carbon fiber was stitched so that width and height intervals are 3 mm each, and both ends of the PITCH-based carbon fiber were each made to protrude 3 mm from the outermost surface of the prepreg laminate.

The stitched prepreg laminate was thermally cured for 140 minutes at 132° C. using an autoclave to manufacture a highly thermally conductive composite material. In addition, during the thermal curing process, the end of the PITCH-based carbon fiber penetrating the prepreg laminate was compressed at a pressure of 6 atm under vacuum to bend and fix in the direction of a surface of the thermally conductive composite material. Herein, a plurality of strands at the end of the PITCH-based carbon fiber were bent in a radial shape.

### Example 2-1 to Example 2-3, Comparative Example 1 and Comparative Example 2

Highly thermally conductive composite materials of Example 2-1 to Example 2-3, Comparative Example 1 and Comparative Example 2 were manufactured in the same manner as in Example 1, except that the type of carbon fiber included in the prepreg, the performing of stitching and the stitching interval were adjusted as in Table 1.

TABLE 1

| | | Performing of | Stitching | |
|---|---|---|---|---|
| | Carbon Fiber Type | Stitching | Interval | |
| Example 1 | Polyacrylonitrile- | ◯ | 3 | mm |
| | based | | | |
| | carbon fiber | | | |
| Example 2-1 | PITCH-based | ◯ | 3 | mm |
| | carbon fiber | | | |
| Example 2-2 | PITCH-based | ◯ | 5 | mm |
| | carbon fiber | | | |
| Example 2-3 | PITCH-based | ◯ | 10 | mm |

| | | | |
|---|---|---|---|
| | carbon fiber | | |
| Comparative | Polyacrylonitrile- | X | — |
| Example 1 | based carbon | | |
| | fiber | | |
| Comparative | PITCH-based | X | — |
| Example 2 | carbon fiber | | |

### Experimental Example 1. Measurement of Through-Thickness Thermal Conductivity of Highly Thermally Conductive Composite Material

For each of the highly thermally conductive composite materials manufactured in Example 1, Example 2-1 to Example 2-3, Comparative Example 1 and Comparative Example 2, through-thickness thermal conductivity was measured in compliance with the ASTM E1461 standard, and the results are shown in FIG. 3.

Specifically, in-plane thermal diffusivity of each of the composite materials manufactured in the examples and the comparative examples was measured using LFA-467 (NETZSCH Group), and through-thickness thermal conductivity of the composite material was derived according to the following Mathematical Equation 1.

$$λ = α \times {C}_{p} \times ρ \qquad [ Mathematical Equation 1 ]$$

In Mathematical Equation 1, λ means thermal conductivity, α means thermal diffusivity, Cₚ means specific heat, and ρ means density.

Referring to FIG. 3, it was identified that through-thickness thermal conductivity of Example 1 in which polyacrylonitrile-based carbon fiber was included and stitching with PITCH-based carbon fiber was performed was about 40.7 times better than through-thickness thermal conductivity of Comparative Example 1 in which polyacrylonitrile-based carbon fiber was included and stitching was not performed.

In addition, it was identified that through-thickness thermal conductivity of Example 2-1 to Example 2-3 in which PITCH-based carbon fiber was included and stitching with PITCH-based carbon fiber was performed was better than through-thickness thermal conductivity of Comparative Example 2 in which PITCH-based carbon fiber was included and stitching was not performed.

In particular, it was identified that through-thickness thermal conductivity of Example 2-1 was about 2.8 times better than through-thickness thermal conductivity of Comparative Example 2.

### Experimental Example 2. Measurement of In-Plane Thermal Conductivity of Highly Thermally Conductive Composite Material

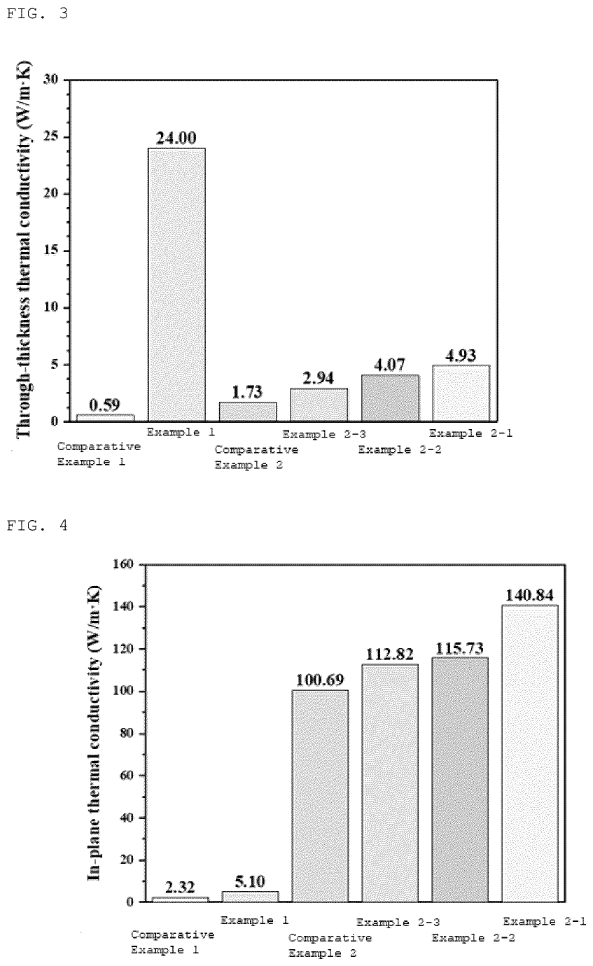

For each of the highly thermally conductive composite materials manufactured in Example 1, Example 2-1 to Example 2-3, Comparative Example 1 and Comparative Example 2, in-plane thermal conductivity was measured in compliance with the ASTM E1461 standard, and the results are shown in FIG. 4.

Specifically, due to a problem that the thickness of each of the composite materials manufactured in the examples and the comparative examples was too thin to measure in-plane thermal diffusivity, the composite material was cut in the lamination direction, then the cut laminate was laminated again so that the total thickness becomes 10 mm, and then in-plane thermal diffusivity of the composite material was measured using LFA-467 (NETZSCH Group), and in-plane thermal conductivity of the composite material was derived according to Mathematical Equation 1.

Referring to FIG. 4, it was identified that in-plane thermal conductivity of Example 1 in which polyacrylonitrile-based carbon fiber was included and stitching with PITCH-based carbon fiber was performed was about 2.2 times better than in-plane thermal conductivity of Comparative Example 1 in which polyacrylonitrile-based carbon fiber was included and stitching was not performed.

In addition, it was identified that in-plane thermal conductivity of Example 2-1 to Example 2-3 in which PITCH-based carbon fiber was included and stitching with PITCH-based carbon fiber was performed was better than in-plane thermal conductivity of Comparative Example 2 in which PITCH-based carbon fiber was included and stitching was not performed.

In particular, it was identified that in-plane thermal conductivity of Example 2-1 was about 1.4 times better than in-plane thermal conductivity of Comparative Example 2.

### Experimental Example 3. DCB Mode I Evaluation

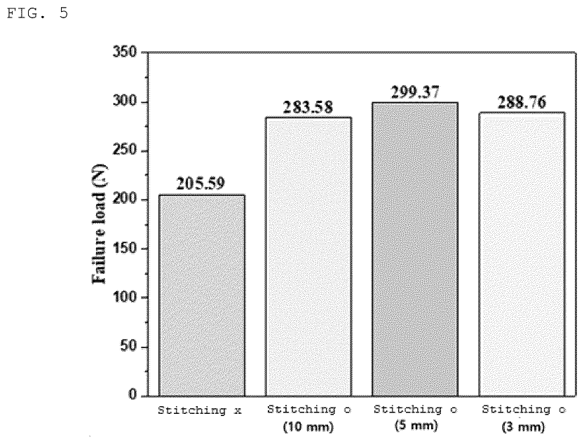

DCB (Double Cantilever Beam) mode I evaluation was performed to measure a failure load of the interlayer joint area depending on the performing of stitching and the stitching interval in the prepreg laminate, and the results are shown in FIG. 5.

Specifically, the prepreg was laminated in two layers, and then laminates with no stitching or stitched at stitching interval of 3 mm, 5 mm and 10 mm were manufactured. For each of the laminates with no stitching or stitched at a stitching interval of 3 mm, 5 mm and 10 mm, a failure load was measured by applying tensile force to the top and the bottom at the left side end at a rate of 3 mm/min using a Zwick Z010 universal testing machine.

Referring to FIG. 5, it was identified that the failure load of the laminates stitched at a stitching interval of 3 mm, 5 mm and 10 mm was larger than the failure load of the laminate with no stitching.

Hereinbefore, the present disclosure has been described with limited examples, however, the present disclosure is not limited thereto, and it is obvious that various changes and modifications may be made by those skilled in the art within technical ideas of the present disclosure and the range of equivalents of the claims to be described.

### REFERENCE NUMERAL

10: Highly thermally conductive composite material
100: Prepreg
110: Prepreg laminate
200: PITCH-based carbon fiber having both ends protruding
210: Interval between PITCH-based carbon fibers having both ends protruding

1. A highly thermally conductive composite material comprising:
a prepreg laminate in which a plurality of prepregs including carbon fiber and a thermosetting resin are laminated; and
a plurality of PITCH-based carbon fibers penetrating the prepreg laminate in the lamination direction to have both ends protruding,
wherein the protruding both ends of the PITCH-based carbon fiber are bent in a direction of a surface of the prepreg laminate.

2. The highly thermally conductive composite material of claim 1, wherein the carbon fiber included in the prepreg is one or more selected from among polyacrylonitrile-based carbon fiber and PITCH-based carbon fiber.

3. The highly thermally conductive composite material of claim 1, wherein the plurality of PITCH-based carbon fibers having both ends protruding penetrate at an interval of 3 mm to 15 mm.

4. The highly thermally conductive composite material of claim 1, wherein the thermosetting resin is an epoxy resin.

5. The highly thermally conductive composite material of claim 1, wherein the prepreg has a thickness of 0.1 mm to 10 mm.

6. The highly thermally conductive composite material of claim 1, wherein the PITCH-based carbon fiber is formed with a plurality of strands, and the protruding both ends of the PITCH-based carbon fiber are the plurality of strands being bent in a radial shape.

7. The highly thermally conductive composite material of claim 3, wherein lengths of the protruding both ends of the PITCH-based carbon fiber are each less than or equal to an interval between the plurality of PITCH-based carbon fibers having both ends protruding, and are from 2 mm to 8 mm.

8. A method for manufacturing the highly thermally conductive composite material of claim 1, the method comprising:
preparing a prepreg laminate by laminating a plurality of prepregs including carbon fiber and a thermosetting resin;
preparing a stitched prepreg laminate by stitching a plurality of PITCH-based carbon fibers so as to penetrate the prepreg laminate in the lamination direction to have both ends protruding; and
compressing and bending the protruding both ends of the PITCH-based carbon fiber while heating and curing the stitched prepreg laminate.

9. The method of claim 8, wherein the curing is performed by heating at a temperature of 100° C. to 150° C.
